(19) United States
(12) Patent Application Publication
(10) Pub. No.: US 2008/0202672 A1
(43) Pub. Date: Aug. 28, 2008

(54) Method of Making Product From Fusible Sheets and/or Elements

(75) Inventor: Judson A. Bradford, Holland, MI (US)

Correspondence Address: WOOD, HERRON & EVANS, LLP, 2700 CAREW TOWER, 441 VINE STREET, CINCINNATI, OH, 45202, US

(73) Assignee: BRADFORD COMPANY, Holland, MI (US)

(21) Appl. No.: 11/678,203

(22) Filed: Feb. 23, 2007

(51) Int. Cl. B31F 1/20

(52) U.S. Cl. 156/210; 428/116

(57) ABSTRACT

A product for use alone or in a sandwich material is provided which may made from a plurality of plastic corrugated sheets. The product may include one or more non-corrugated plastic or foam elements. Each of the elements or sheets are grouped together to form a stack which is cut to fuse adjacent elements or sheets together without the need for any additional material.

### FIELD OF THE INVENTION

This invention relates generally to a product for structural, packaging and other applications and the process of making the product.

### BACKGROUND OF THE INVENTION

In the aerospace industry, honeycomb cores, products or structures have preferably been used for many decades as core material for sandwich panels and boards that are resistant to buckling and bending. These honeycomb cores, which in cross-section have a generally hexagonal shape, are fabricated from aluminum or fiber paper or plastic. A sandwich structure may be prepared having two cover layers or skins adhesively bonded or otherwise secured to the honeycomb core to create a multi-laminate material which may have a high stiffness to weight ratio and a relatively high strength to weight ratio. Interest expressed by other industries in lightweight sandwich structures is continually growing, due at least in part to the realization of its high strength properties while maintaining low structural weight per volume of product.

The use of multi-laminate material having a honeycomb core may be used in the packaging industry. However, in automobile part packaging and comparable markets, such a product must compete with corrugated paper board or corrugated plastic or other like materials which may be produced quickly and relatively inexpensively.

U.S. Pat. No. 6,183,836 discloses a honeycomb core for use in a sandwich material in which the material of the honeycomb core is cut and then folded to create a plurality of hexagonal cells from a single planar layer or web. Due to the cuts in the web prior to folding the web, the resultant cells may be weaker than desired.

A process for producing a folded honeycomb core for use in sandwich materials from a continuous uncut web is disclosed in U.S. Pat. No. 6,726,974. U.S. Pat. No. 6,800,351 discloses another process for producing a folded honeycomb core which includes scoring a corrugated material before rotating interconnected corrugated strips. The honeycomb core resulting from using either of these methods may be relatively expensive due to the complexity of the processes used to make the honeycomb core.

Accordingly, there is a need for a core product which may be used alone or in a multi-layered material which has approximately the same high strength to weight ratio as honeycomb core products but may be produced less costly and more efficiently.

There is further a need for a process for manufacturing a core product for use alone or in a multi-layered or sandwich material which is less expensive and may be produced faster than heretofore known processes.

### SUMMARY OF THE INVENTION

These and other objectives of the invention have been attained by a product made, at least partially, from corrugated plastic sheets. The product may be used, for example, in a multi-layered or sandwich material or alone. The product of the present invention may be used in any desired environment or industry alone or combined with other materials. One or more processes of making this product may be efficient for making low volumes of product, such as custom made products.

According to one aspect of the invention, the product comprises a stack of corrugated plastic sheets joined to each other without any additional material. Heat generated by the process of making the product fuses adjacent plastic corrugated sheets together or to other like materials to make a unitary product without any adhesive or additional material.

According to one embodiment of the invention, each of the sheets has opposed outer layers which are generally planar and spaced from each other by a plurality of spaced ribs extending between the outer layers. A plurality of flutes are defined by the spaced ribs and outer layers. In some embodiments, the ribs and corresponding flutes may be generally parallel each other.

According to another embodiment of the invention, each of the sheets has generally flattened peaks and generally flattened valleys joined by generally planar connecting portions.

According to one aspect of the invention, the ribs of adjacent sheets are offset from one another in the product. In such an embodiment or other embodiments, the thickness of the ribs may be twice the thickness of the outer skins so that when multiple sheets are stacked and fused together, the thickness of the ribs is approximately equal to the thickness of two outer skins stacked on each other. One benefit of making the product with extruded sheets having ribs with twice the thickness of the outer skins is that the strength of the resultant product is approximately the same longitudinally and transversely. Another benefit of this aspect of the invention is that the width of the flutes of the sheets may be twice the height of the flutes regardless of the length of the flutes. This results in less plastic being required to make the extruded plastic corrugated sheet due to fewer ribs being required.

The product may be manufactured via numerous processes. Each process comprises providing a plurality of corrugated plastic sheets and stacking them in a desired manner without the need to join them together in the stack prior to cutting. For purposes of this document, the term “stack” is not intended to be limited to sheets placed vertically on top of each other. A “stack” may be a group or gang of sheets aligned with each other in any desired orientation. For example, a “stack” may be sheets oriented on edge. In one process, a plurality of plastic corrugated sheets are stacked on one another in a stack such that the flutes of at least two adjacent plastic corrugated sheets are oriented in the same direction, a first direction. In one embodiment, all of the plastic corrugated sheets are oriented the same direction so the flutes of all of the sheets are oriented in the same direction, a first direction.

During this process, the next step comprises making a first cut at least partially through the stack along a first plane generally orthogonal or perpendicular to the first direction, the first cut defining a first surface of the product. The next step in the process is making a second cut at least partially through the stack along a second plane generally orthogonal or perpendicular to the first direction and substantially parallel the first plate, the second cut defining a second surface of the product. These cuts may be made in any desired manner. However, one proven method of making these cuts is using a band saw. Heat generated by making these cuts causes thermal fusion of adjacent outer layers of adjacent plastic corrugated sheets to fuse adjacent sheets together without any additional material.

If used in a multi-layered or sandwich material or product, one or more skins may be applied, secured or otherwise attached to the first and/or second surfaces of the core product to create a multi-layered or multi-laminate material.

According to another aspect of this invention, the sheets may be stacked in any desired manner. All the sheets may be oriented in the same direction with the ribs and flutes therebetween extending generally in the same direction. In other variations, the sheets may be oriented in any desired direction.

According to another aspect of this invention, sheets having different densities or different material properties may be incorporated into the stack. One benefit of using sheets having different densities or different material properties in the stack is that after the cutting is over, the resultant product may have different strengths in different areas.

If desired one or more non-uniform sheets may be incorporated into the stack used to make the product. For purposes of this document the term “non-uniform” sheet means a sheet having different material properties in different regions or sections. Such a non-uniform sheet may be made by joining multiple pieces of material together by any desired method such as adhesives, thermal fusion or welding, for example. The pieces or sections used to make such a non-uniform sheet may be foam, plastic and/or corrugated or non-corrugated.

According to another aspect of this invention, one or more non-corrugated elements of any desired size (length, width or height) may be incorporated into the stack. Examples of such non-corrugated elements include polypropylene, foam, thermoplastic or any other fusible material. As a result of the cutting processes, such elements are thermal fused or welded to the other sheets or portions thereof in the stack to create a unitary product. One benefit of including such elements having different material properties such as density in the stack is that after the cutting is over, the resultant product may have different strengths in different areas, sections or regions.

Regardless of the process used to create the product, one advantage of this invention is that a lightweight, strong product may be quickly and easily manufactured in any desired size or height. The product of this invention has a relatively high strength to weight ratio and may be made from many different materials quickly and less costly than heretofore. The product may be used alone, incorporated into a multi-layered material or used in any other desired manner.

### BRIEF DESCRIPTION OF THE DRAWINGS

The objectives and features of the present invention will become more readily apparent when the following detailed description of the drawings is taken in conjunction with the accompanying drawings in which:

FIG. 1 is a perspective view of a sheet of corrugated plastic from the prior art;

FIG. 2 is an end view of the sheet of FIG. 1;

FIG. 3 is a perspective view of a sheet of corrugated plastic in accordance with one aspect of the present invention;

FIG. 4 is an end view of the sheet of FIG. 3;

FIG. 4A is an end view of an alternative embodiment of sheet;

FIG. 5 is a perspective view of a stack of corrugated plastic sheets used to make a product in accordance with the present invention;

FIG. 5A is an enlarged side elevational view of a portion of the stack of FIG. 5;

FIG. 5B is an enlarged side elevational view of a portion of a stack of corrugated plastic sheets showing a different embodiment;

FIG. 6 is a perspective view of the stack of FIG. 5 being cut to form a product;

FIG. 7 is a perspective view of top and bottom skins being applied to the product of FIG. 6 to make a sandwich material;

FIG. 8 is a perspective view of sandwich material of FIG. 7 illustrating the skins being cut;

FIG. 9 is a perspective view of several pieces of material being fused together to form a non-uniform sheet;

FIG. 9A is a perspective view of several pieces of material being fused together to form another non-uniform sheet;

FIG. 10 is a perspective view of the non-uniform sheet of FIG. 9 being incorporated into a stack including different corrugated plastic sheets and non-corrugated elements in accordance with the present invention;

FIG. 11 is a perspective view of the stack of FIG. 10 being cut to form a product;

FIG. 12 is a perspective view of the stack of FIG. 11 after having been cut;

FIG. 13 is a perspective view of a sheet of corrugated plastic in accordance with another aspect of the invention;

FIG. 14 is a perspective view of a stack of sheets like the sheet shown in FIG. 13; and

FIG. 15 is a side elevational view of the stack of FIG. 14.

### DETAILED DESCRIPTION OF THE DRAWINGS

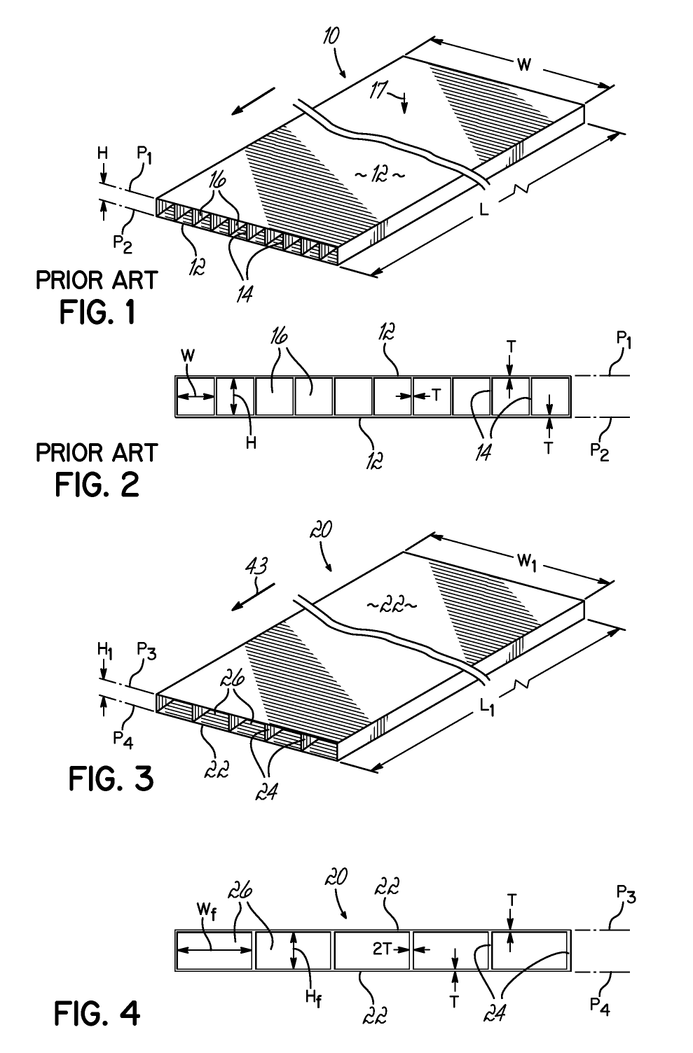

Referring to FIG. 1, a prior art extruded sheet of corrugated plastic 10 is shown. The sheet 10 has a length L, a width W and a height H. The sheet 10 comprises a pair of generally planar rectangular outer layers 12, each outer layer 12 having a thickness T, as shown in FIG. 2. As seen in FIG. 2, the top outer layer 12 is located in plane P1 and bottom outer layer 12 is located in plane p2. A plurality of transversely spaced ribs 14 extend between the outer layers 12, each rib 14 having a thickness T identical to the thickness of each of the outer layers 12 and extending the length of the sheet 10. A plurality of flutes or openings 16 are located between the ribs 14, each flute 16 extending the length of the sheet 10. Each flute 16 of sheet 10 has a width w, the linear distance between adjacent ribs 14 and a height h, the linear distance between the inner surfaces of the outer layers 12.

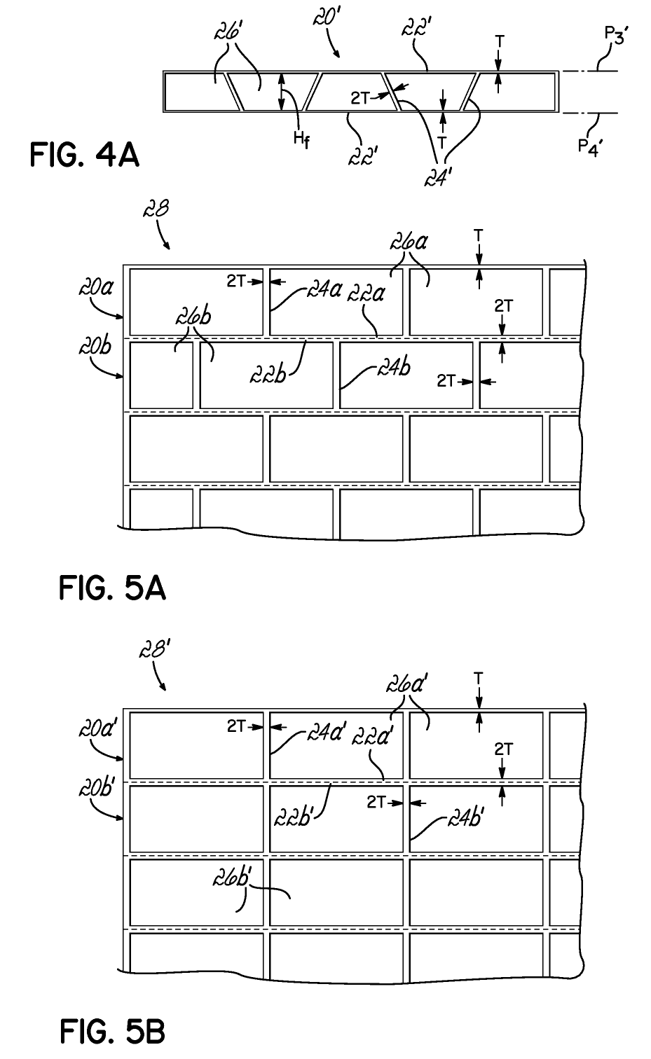

FIGS. 3 and 4 illustrate an extruded sheet of corrugated plastic 20 made in accordance with one aspect of the present invention. The sheet 20 has a length L1, a width W1 and a height H1. The sheet 20 comprises a pair of generally planar rectangular outer layers 22, each outer layer 22 having a thickness T, the same thickness as the thickness of the outer layers 12 and ribs 14 of sheet 10. As shown in FIG. 4, the top outer layer 22 is located in plane P3 and bottom outer layer 22 is located in plane p4. A plurality of transversely spaced and longitudinally extending ribs 24 extend between the outer layers 22. Each rib 24 has a thickness 2 T, twice the thickness of each of the outer layers 22 and extending the length L1 of the sheet 20. A plurality of flutes 26 are located between the ribs 24, each flute 26 extending the length of the sheet 20. Each flute 26 has a width Wf, the linear distance between adjacent ribs 24 and a height Hf, the linear distance between the inner surfaces of the outer layers 22. The width Wf of each flute 26 of sheet 20 is twice the width w of the flutes 16 of the sheet 10 while the heights h and Hf of the flutes 16, 26 are identical.

Referring back to FIGS. 1 and 2, due to the thickness of the ribs 14 being equal the thickness of each outer sheet 12, the sheet 10 must have a certain number of ribs 14 to have a predetermined compressive strength to withstand forces in the direction of arrow 17 (for example if someone stepped on sheet 10). With the embodiment of the present invention illustrated in FIGS. 3 and 4, the number of ribs 14 may be reduced in sheet 20 when compared to sheet 10 of the prior art because of the increased thickness of the ribs 24 of sheet 20 (twice the thickness of the ribs 14 of sheet 10) and still achieve the same compressive strength as sheet 10.

FIG. 4A illustrates an alternative embodiment of plastic corrugated sheet 20′. The sheet 20′ comprises a pair of generally planar rectangular outer layers 22′, each outer layer 22′ having a thickness T, the same thickness as the thickness of the outer layers 12 and ribs 14 of sheet 10 shown in FIGS. 1 and 2. As shown in FIG. 4, the top outer layer 22′ is located in plane P3′ and bottom outer layer 22′ is located in plane P4′. A plurality of transversely spaced and longitudinally extending ribs 24′ extend between the outer layers 22′. Each rib 24′ has a thickness 2 T, twice the thickness of each of the outer layers 22′ and extending the length of the sheet 20′. A plurality of flutes 26′ are located between the ribs 24′, each flute 26′ extending the length of the sheet 20′. Unlike the embodiment shown in FIGS. 3 and 4, the ribs 24′ are not perpendicular to the outer layers 22′ but slightly angled relative to the outer sheets 22′.

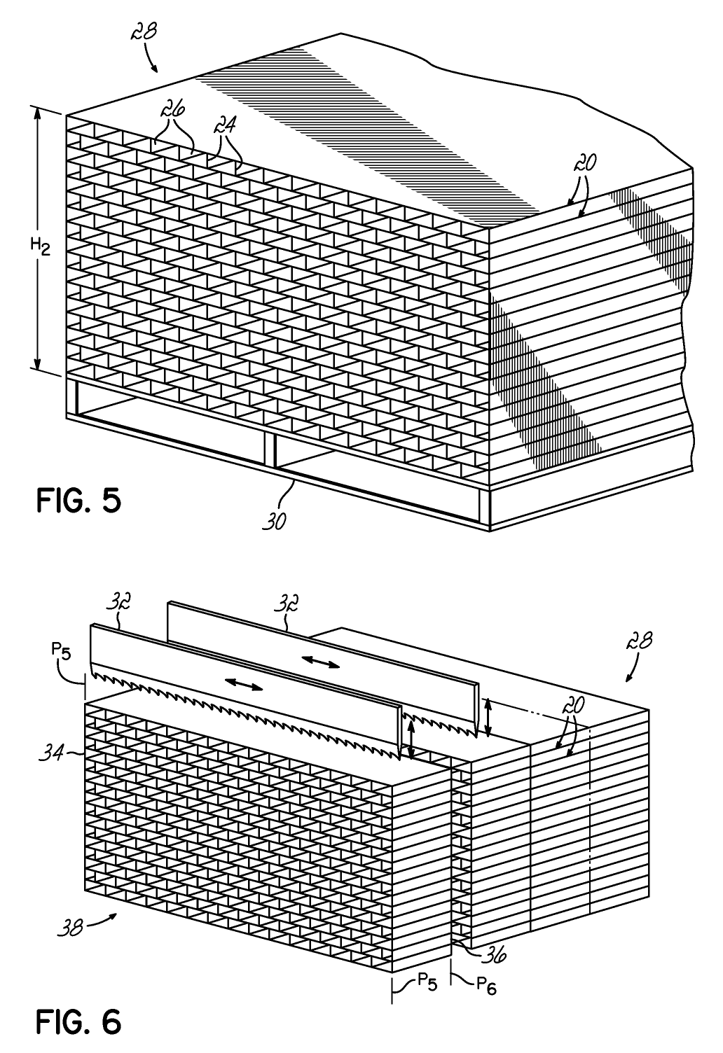

FIG. 5 illustrates a plurality of plastic corrugated sheets 20 stacked, grouped or ganged on top of each other to form a stack 28 located on top of pallet 30. In the embodiment illustrated in FIG. 5, each of the sheets 20 is oriented the same direction with the ribs 24 and flutes 26 extending from front to back in a first direction. Although FIG. 5 shows seventeen sheets 20 stacked on one another to form a stack 28 of a height H2, any number of sheets 20 may be stacked to form a stack of any desired height. Although sheets of one size are illustrated, the sheets may be any desired size or thickness.

FIG. 5A illustrates a top portion of stack 28 the top sheet 20a being offset from the next lowest sheet 20b so that the ribs 24a, 24b and flutes 26a, 26b of adjacent layers or sheets are horizontally offset from one another. The outer layers 22a of the top sheet 20a have a thickness T while the ribs 24a have a thickness 2 T, twice the thickness of the outer layers or skins 22a. Similarly, outer layers 22b of the next lowest sheet 20b have a thickness T while the ribs 24b have a thickness 2 T, twice the thickness of the outer layers or skins 22b. When the sheets 20a and 20b are stacked, the combined outer layers 22a, 22b have a thickness 2 T. This offset configuration shown in FIG. 5A may provide additional stacking strength.

FIG. 5A illustrates one advantage of using plastic corrugated sheets 20 like those shown in FIGS. 3 and 4 in the stack 28. Because the thickness of each of the ribs 24 is twice the thickness of each outer sheet 22, when two sheets 20 are stacked on top of each other, the combined thickness of adjacent contacting outer skins 22 has the same thickness 2 T as the thickness of each of the ribs 24 of sheets 20. The result of this configuration of sheets 20 is that the core resulting from further processing the stack 28 of sheets 20 as described below has the same compressive strength to withstand forces extending longitudinally and transversely.

FIG. 5B illustrates an alternative embodiment in which a top portion of a stack 28′ has a top sheet 20a′ and an adjacent sheet 20b′, the ribs 24a′ and flutes 26a′ of sheet 20a′ being aligned with the ribs 24b′ and flutes 26b′ of the next lowest sheet 20b′. Although FIGS. 5A and 5B illustrate predetermined arrangements of layers or sheets, any variation thereof may be used in accordance with this invention.

Although the drawings illustrate sheets 20 including the ribs 24 and flutes 26 being a certain size, the sheets 20 including the ribs 24 and flutes 26 may be any desired size.

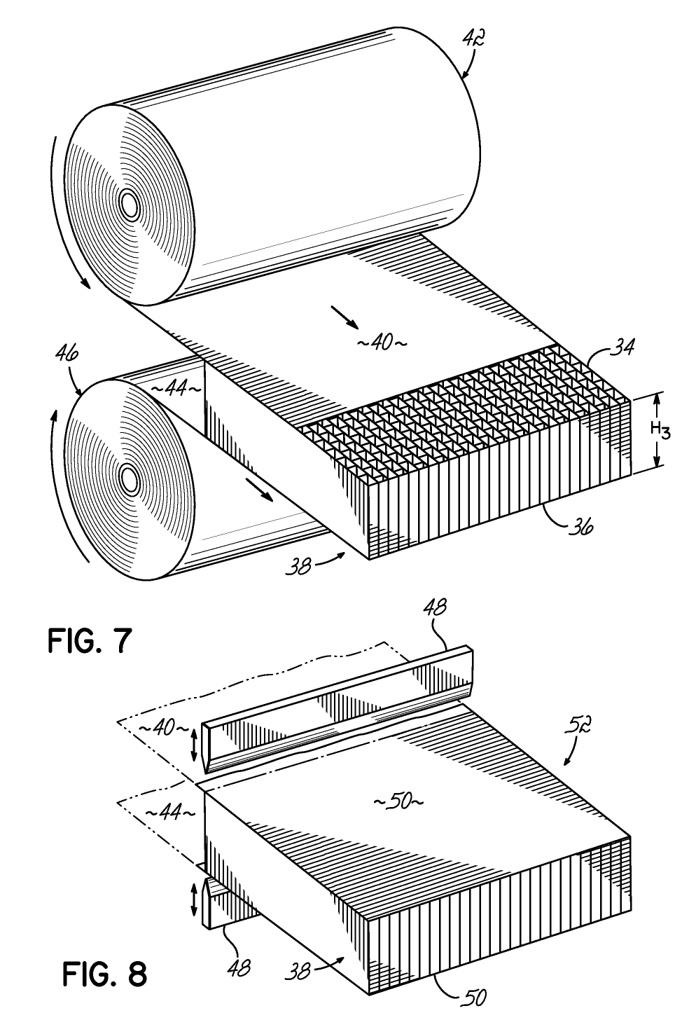

FIG. 6 illustrates the stack 28 being cut along a first plane P5 with a band saw 32 to define a generally planar first surface 34 of the resultant product 38, the first plane P5 being generally perpendicular to the first direction (from front to back). Although not shown, any portion of stack 28 in front of the first plane P5 may be discarded or used for any other desired purpose. FIG. 6 illustrates the stack 28 being cut along a second plane P6 with band saw 32 to define a generally planar second surface 36 of the resultant product 38, the second plane P6 being generally perpendicular to the first direction (from front to back) and parallel the first plane P5. The linear distance between the planes P5 and P6 defines the height H3 of the resulting product 38. See FIG. 7. Depending upon the number of cuts and their location, any number of products may be manufactured of any desired height.

The first and second cuts generate heat which fuses or joins abutting outer layers of adjacent sheets or elements together. Therefore, both the top and bottom surfaces 34, 36 of the product 38 have an increased surface area exposed, to which skins may be applied if the product 38 is used in a sandwich or multi-layered material or product. See FIGS. 7 and 8.

In the drawings the first and second planes P5 and P6 are shown as being vertical; however they may be horizontal or in any orientation as long as they are perpendicular to the first direction as defined herein. For example if the stack 28 were oriented with the flutes of the sheets extending vertically, the cuts would be made generally horizontally.

FIG. 7 illustrates a first web 40 of skin material being unrolled from roll 42 and a second web 44 of skin material being unrolled from roll 46, the rolls rotating in opposite directions. The first web 40 covers the first surface 34 of product 38 and the second web 44 covers the second surface 36 of product 38. Although rolls are illustrated, the webs 40, 44 may be supplied pre-cut or from a stack rather than a roll of material.

FIG. 8 illustrates the first and second webs 40, 44 of skin material being cut to the appropriate size with cutters 48, as is known in the art. After the webs 40, 44 have been cut to a size sufficient to cover the first and second surfaces 34, 36 of product 38 they may be secured to the core product 38 in any desired manner and considered skins 50 on the outside of a sandwich material or product 52 shown in FIG. 8. Any of the embodiments of this invention may be covered with skins to create a sandwich-like or layered material.

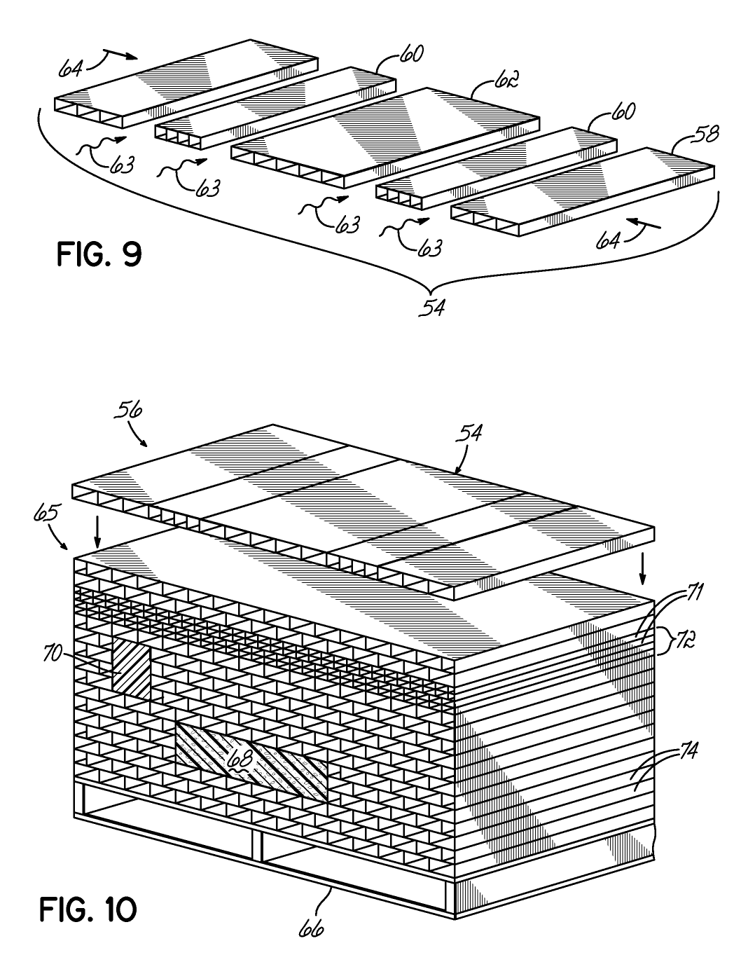

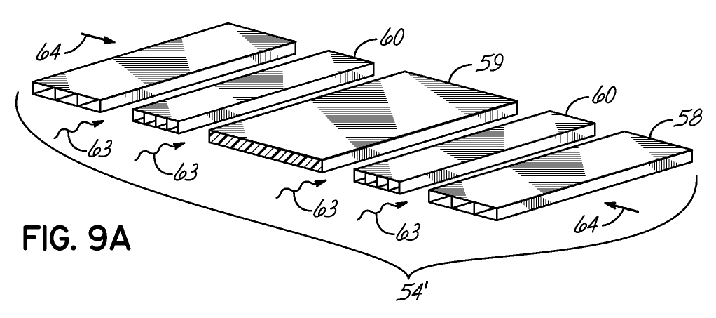

FIG. 9 illustrates a process or method of manufacturing a non-uniform sheet of corrugated plastic material. The non-uniform sheet of corrugated plastic material 54 is shown assembled in FIG. 10 and incorporated into a stack 56. Although FIG. 10 illustrates only one non-uniform sheet 54 being incorporated into stack 56, any number of such non-uniform sheets 54 may be used in making the stack 56 and placed at any desired locations in the stack.

As shown in FIG. 9, to make the non-uniform sheet of corrugated plastic material 54, one may fuse multiple pieces or sections 58, 60 and 62 together using heat shown schematically by arrows 63. By compressing these sections 58, 60 and 62 together in the direction of arrows 64 and allowing the sections 58, 60 and 62 to cool, the sections or pieces become fused or joined together. The pieces or sections 58, 60 and 62 may have different densities or material properties. For example, pieces 58 may each have a density of 3000 grams per square meter (“gms”) while pieces 60 may have a density of 2000 gms and piece 62 may have a density of 1000 gms. These density numbers are merely for illustration only and are not intended to limit the present invention. Although, the non-uniform sheet 54 is illustrated being made of five pieces of corrugated plastic, it may be made of any number of pieces of any desired size, as long as the material properties, such as the density of the material, for example differ in at least two pieces of the sheet. Also, one or more of the sections or pieces may be made of solid plastic, for example, polypropylene or any other thermoplastic or foam.

FIG. 9A illustrates such an alternative non-uniform sheet 54′ made by fusing or joining sections 58 and 60 of corrugated plastic to a piece or section of solid, non-corrugated plastic 59. Although FIG. 9A illustrates only one piece of solid plastic 59 being incorporated into a non-uniform sheet, any number of such pieces of any desired size may be incorporated into such a sheet. The same is true for pieces of foam or any other fusible material which may be joined to each other or to one or more sections of corrugated plastic.

FIG. 10 illustrates non-uniform sheet 54 being placed on top of a partial stack 65 loaded on a pallet 66. The partial stack 65 includes a non-corrugated foam element or block 68 having a rectangular cross-section which may or may not extend the full depth of the partial stack 65. The partial stack 65 further includes a non-corrugated solid plastic element or block 70 having a rectangular cross-section which may or may not extend the full depth of the partial stack 65. These elements 68, 70 may fuse to the corrugated plastic sheets or portions thereof as a result of the cutting process. Although only one foam element or block 68 and one solid plastic element or block 70 are illustrated being incorporated into stack, any number of such elements of any desired size may be incorporated into a stack before the stack is cut in accordance with the present invention.

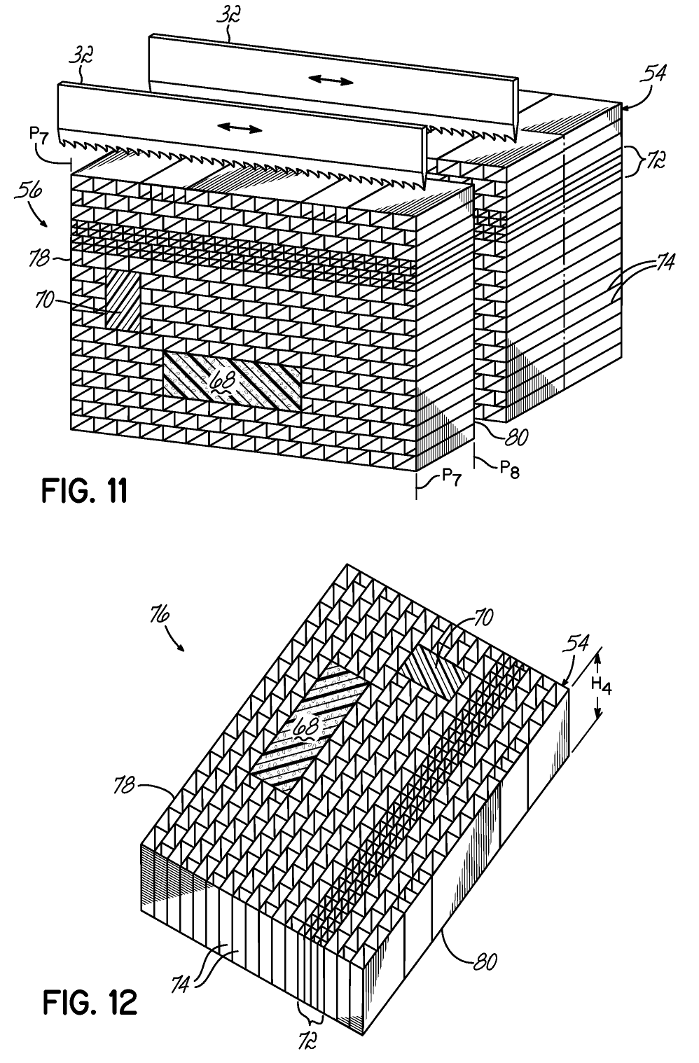

FIG. 10 also includes several stacked like sheets or layers of plastic corrugated material 71 comprising a section 72. These sheets 71 have a different density or different material properties from the other plastic corrugated sheets 74. FIG. 10 shows plastic corrugated sheets 71 having more flutes than the sheets 74 and therefore a greater density, for example. The incorporation into the stack 56 of either sheets having different material properties such as density, for example, or non-uniform sheets made of multiple pieces or sections having different properties results in a product 76 after cutting (see FIG. 11) which has different firmness or characteristics in different regions or areas of the product.

FIG. 11 illustrates the stack 56 being cut along a first plane P7 with a band saw 32 to define a generally planar first surface 78 of the resultant product 76, the first plane P7 being generally perpendicular to the first direction (from front to back). Although not shown, any portion of stack 56 in front of the first plane P7 may be discarded or used for any other desired purpose. FIG. 11 illustrates the stack 56 being cut along a second plane P8 with band saw 32 to define a generally planar second surface 8o of the resultant product 76, the second plane P8 being generally perpendicular to the first direction (from front to back) and parallel the first plane P7. The linear distance between the planes P7 and P8 defines the height H4 of the resulting product 76. See FIG. 11.

The first and second cuts generate heat which fuses or joins abutting outer layers of adjacent sheets or elements together. Therefore, both the top and bottom surfaces 78, 80 of the product 76 have an increased surface area exposed, to which skins may be applied if the product 76 is used in a sandwich or multi-layered material or product. See FIGS. 7 and 8.

In FIG. 11, the first and second planes P7 and P8 are shown as being vertical; however they may be horizontal or in any orientation as long as they are perpendicular to the first direction as defined herein. For example if the stack 56 were oriented with the flutes of the sheets extending vertically, the cuts would be made generally horizontally.

FIG. 12 shows a unitary product 76 made by cutting the stack 56 shown in FIG. 11 along parallel planes in accordance with the principals discussed above. No additional glue or adhesive is required to adhere the sheets or elements to each other.

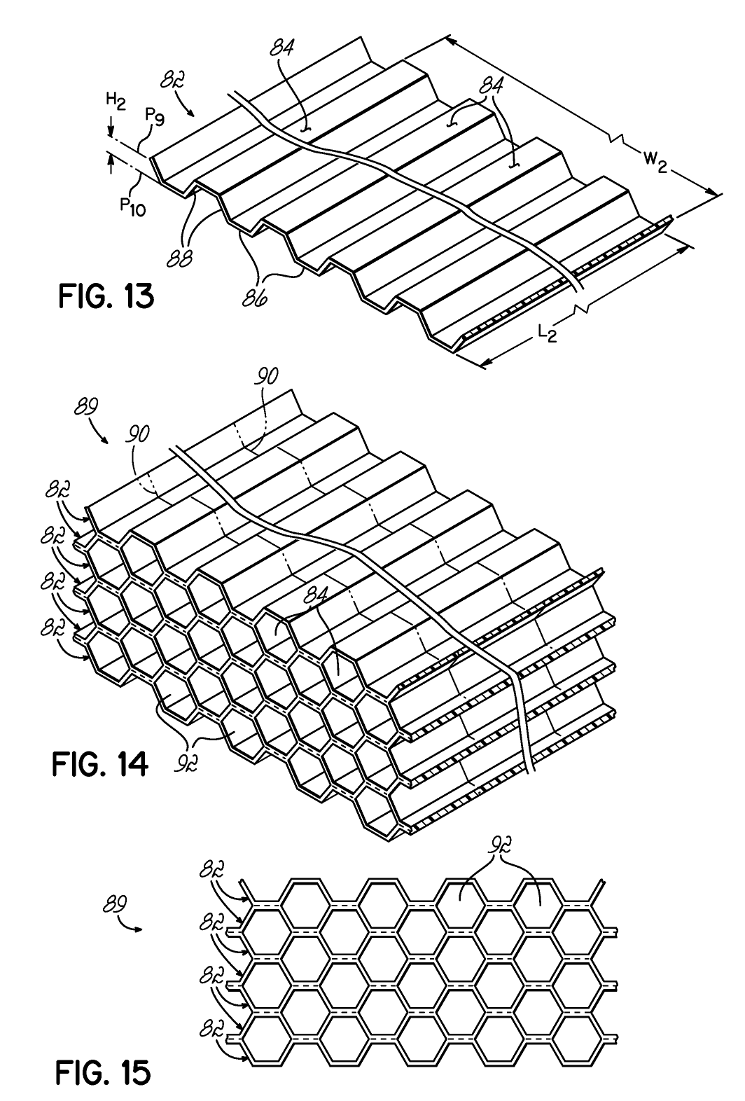

FIG. 13 illustrates an extruded sheet of corrugated plastic 82 made in accordance with another aspect of the present invention. The sheet 82 has a length L2, a width W2 and a height H2. The sheet 82 comprises a plurality of generally planar or flattened peaks 84, a plurality of generally planar or flattened valleys 86 and a plurality of generally planar connecting sections 88, each extending the length L2 of the sheet 82. As shown in FIG. 4, the flattened peaks 84 are located in plane P9 and the flattened valleys 86 are located in plane p10. The linear distance between planes P9 and P10 equals the height H2 of the sheet 82.

FIGS. 14 and 15 illustrate a plurality of extruded sheets of corrugated plastic 82 stacked on top of one another to form a stack 89 prior to cutting along transversely extending cut lines 90 in accordance with the present invention. In the stack 89, the contacting peaks and valleys create a plurality of passages 92 extending longitudinally through the stack 89. See FIG. 15.

While I have described several preferred embodiments of the present invention, persons skilled in the art will appreciate changes and modifications which may be made without departing from the spirit of the invention. For example, although one configuration of a cell is illustrated and described, the cells of the present invention may be other configurations, such as cylindrical in shape. Therefore, I intend to be limited only by the scope of the following claims and equivalents thereof:

I claim:

1. A process of making a product comprising:
providing a plurality of plastic corrugated sheets;
stacking the sheets to form a stack, each of the sheets having opposed outer layers and spaced ribs extending between the outer layers to define a plurality of flutes, the flutes of at least two adjacent sheets in the stack being oriented in a first direction;
making a first cut at least partially through the stack along a first plane generally perpendicular the first direction, thereby defining a first surface of the product;
making a second cut at least partially through the stack along a second plane spaced from and substantially parallel the first plane, thereby defining a second surface of the product;
wherein making the first and second cuts causes thermal fusion of adjacent outer layers of adjacent plastic corrugated sheets, fusing adjacent sheets without any additional material.

2. The process of claim 1 wherein making the first and second cuts comprises using at least one saw blade.

3. The process of claim 1 wherein the sheets are stacked such that ribs of adjacent sheets are offset from one another.

4. The process of claim 1 wherein all the sheets in the stack are oriented with their flutes extending in the first direction.

5. The process of claim 1 wherein stacking the sheets comprises stacking sheets having different densities.

6. The process of claim 1 wherein stacking the sheets comprises stacking sheets having different dimensions.

7. The process of claim 1 wherein stacking the sheets comprises stacking sheets having different material properties.

8. The process of claim 1 wherein stacking the sheets includes stacking at least one non-uniform sheet having different sections with different densities within the sheet.

9. The process of claim 1 further comprising manufacturing a non-uniform sheet by joining multiple pieces of material having different material properties and including the non-uniform sheet in the stack.

10. The process of claim 1 further comprising including a non-corrugated element in the stack.

11. The process of claim 1 further comprising including a plastic non-corrugated element in the stack.

12. The process of claim 1 further comprising including a foam element in the stack.

13. The process of claim 1 further comprising including a polypropylene element in the stack.

14. The process of claim 1 further comprising including a thermoplastic element in the stack.

15. The product made by the process of claim 1.

16. A process of making a product comprising:
stacking a plurality of plastic corrugated sheets to form a stack, each of the sheets having opposed outer layers and spaced ribs extending between the outer layers to define a plurality of flutes, the flutes of all the sheets in the stack being oriented in a first direction;
making a first cut at least partially through the stack along a first plane generally perpendicular the first direction, thereby defining a first surface of the product;
making a second cut at least partially through the stack along a second plane spaced from and substantially parallel the first plane, thereby defining a second surface of the product;
wherein making the first and second cuts causes thermal fusion of adjacent plastic corrugated sheets, fusing adjacent sheets without any additional material.

17. The process of claim 16 wherein stacking the sheets comprises stacking sheets having different densities.

18. The process of claim 16 wherein stacking the sheets comprises stacking sheets having different material properties.

19. The process of claim 16 wherein stacking the sheets includes stacking at least one non-uniform sheet having different sections with different densities within the sheet.

20. The process of claim 16 further comprising manufacturing a non-uniform sheet by joining multiple pieces of material having different material properties and including the non-uniform sheet in the stack.

21. The process of claim 16 further comprising including a non-corrugated element in the stack.

22. The process of claim 16 further comprising including a plastic non-corrugated element in the stack.

23. The process of claim 16 further comprising including a foam element in the stack.

24. The process of claim 16 further comprising including a polypropylene element in the stack.

25. The process of claim 16 further comprising including a thermoplastic element in the stack.

26. The product made by the process of claim 16.

27. A process of making a product for use in a sandwich material comprising:
stacking a plurality of plastic corrugated sheets, each of the sheets having opposed outer layers and spaced ribs extending between the outer layers to define a plurality of flutes, the flutes of several of the sheets in the stack being oriented in a first direction;
making parallel cuts through the stack in a direction generally perpendicular the first direction, the linear distance between the cuts defining the height of the product;
wherein making the cuts causes thermal fusion of adjacent plastic corrugated sheets, fusing adjacent sheets without any additional material.

28. The process of claim 27 wherein stacking the sheets comprises stacking sheets having different densities.

29. The process of claim 27 wherein stacking the sheets comprises stacking sheets having different material properties.

30. The process of claim 27 wherein stacking the sheets includes stacking at least one non-uniform sheet having different sections with different densities within the sheet.

31. The process of claim 27 further comprising manufacturing a non-uniform sheet by joining multiple pieces of material having different material properties and including the non-uniform sheet in the stack.

32. The process of claim 27 further comprising including a non-corrugated element in the stack.

33. The process of claim 27 further comprising including a non-corrugated plastic element in the stack.

34. The process of claim 27 further comprising including a foam element in the stack.

35. The process of claim 27 further comprising including a polypropylene element in the stack.

36. The product made by the process of claim 27.

37. A product comprising:
a stack of plastic corrugated sheets joined to each other without any additional material, each of the plastic corrugated sheets having opposed outer layers and spaced ribs extending between the outer layers to define a plurality of flutes, the ribs of adjacent sheets being offset from one another.

38. The product of claim 37 wherein the stack is oriented such that the flutes extend vertically.

39. The product of claim 37 wherein the ribs have a thickness twice the thickness of the outer skins.

40. A stack of plastic corrugated material comprising opposed outer layers and spaced ribs extending between the outer layers to define a plurality of flutes, the ribs of adjacent sheets being offset from one another.

41. The stack of claim 40 wherein the stack is oriented such that the flutes extend vertically.

42. The stack of claim 40 wherein the ribs have a thickness twice the thickness of the outer skins.

43. A sheet of plastic corrugated material comprising opposed outer layers and spaced ribs extending between the outer layers to define a plurality of flutes, the ribs having a thickness twice the thickness of the outer skins.
